(19) United States
(12) Patent Application Publication
(10) Pub. No.: US 2019/0210796 A1
(43) Pub. Date: Jul. 11, 2019

(54) FREIGHT CONTAINER WITH HIGH PERFORMANCE AND INVARIABLE STORAGE AMBIENCE

(71) Applicant: HK IIMO TECHNOLOGY LIMITED, HONG KONG (HK)

(72) Inventor: TING LI, HONG KONG (HK)

(21) Appl. No.: 15/867,794

(22) Filed: Jan. 11, 2018

(51) Int. Cl. B65D 88/74; B65D 81/38; B65D 88/12; B65D 90/02

(52) U.S. Cl. CPC B65D 88/74; B65D 81/3818; H02J 3/381; B65D 88/121; B65D 90/022; B65D 81/3823

(57) ABSTRACT

A freight container with a high performance and an invariable storage ambience includes a bearing base, bearing columns, protective lateral walls, reinforced guide rails, a sealing top cap, an auxiliary electrical power source, a thermostat, air purifiers and a control system. The number of the bearing columns is at least four; the bearing columns surround an axis of the bearing base to be evenly distributed on a top surface of the bearing base. The protective lateral walls are connected with the bearing columns by the connecting slides. Top ends of the protective lateral walls are disposed with connecting slides to be glidingly connected with the sealing, top cap by the connecting slides. The air purifiers are evenly distributed on the inner surface of the airtightness bearing cavity to surround a center of the airtightness bearing cavity. The control system is embedded in an outer surface of the protective lateral walls.

### FIELD OF THE DISCLOSURE

The disclosure relates to a transportation device technical field, and more particularly to a freight container with a high performance and an invariable storage ambience.

### BACKGROUND

A freight container is a critical freight transportation device at present, which is commonly used, but in the practical usage, conventional freight containers generally are simple metal enclosed cavity structures, which have excellent bearing abilities, but the ability of anti-impact, especially the ability of absorbing and transferring the impact energy is limited, which can cause the goods to be destroyed due to the impact, additionally, the conventional freight containers can hardly regulate the ambience in the freight container, resulting in goods deterioration and microorganism contamination in transportation, which severely degrade the quality and safety of the freight. In order to counter the problem, the conventional freight containers can further be equipped with refrigeration devices, which can control the temperature in the freight container effectively, but fail in governing the air quality and contaminative microorganism, and the refrigeration, devices should be powered by the transportation device for work, which further raise the power consumption for running the transportation device, as well as the cost in freight. Aiming at the problem, a novel freight container is urgent to be developed to meet the requirement of the practical usage.

### SUMMARY

An objective of the disclosure is to overcome the shortcomings above and provide a freight container with a high performance and an invariable storage ambience, and a manufacturing process thereof.

In order to fulfill the objective above, the disclosure is achieved by following solutions.

A freight container with a high performance and an invariable storage ambience includes a bearing base, bearing columns, protective lateral walls, reinforced guide rails, a sealing top cap, an auxiliary electrical power source, a thermostat, air purifiers and a control system. The number of the bearing columns is at least four, and the bearing columns surround an axis of the bearing base to be evenly distributed on a top surface of the bearing base. The bearing columns are distributed perpendicularly to the top surface of the bearing base. An outer surface of the bearing column is disposed with at least two connecting slides, and the at least two connecting slides surround an, axis, of the bearing column to be evenly distributed; the at least two connecting slides and the axis of the bearing column are distributed parallel. The protective lateral walls are connected with the bearing columns by the at least two connecting slides. Adjacent protective lateral walls are mutually connected by the reinforced guide rails. Positions on the top surface of the bearing base corresponding to the protective lateral walls are defined with sealing grooves to be connected with the protective lateral walls by the sealing grooves. Top ends of the protective lateral walls are disposed with connecting slides to be glidingly connected with the sealing top cap by the connecting slides. The bearing base, the protective lateral walls and the sealing top cap together form an airtightness bearing cavity; the bearing base, the protective lateral wall and the sealing top cap each include a positioning keel, protective boards and a workbench. The positioning keel is a planar rectangular frame structure. The protective boards cover outer sides of the positioning keel to form an enclosed cavity structure. An outer surface of the protective boards corresponding to a top surface of the positioning keel is connected with the workbench by an elastic positioning mechanism; the workbench and the top surface of the positioning keel are distributed parallel. An elastic sealing layer is disposed between the workbench and the protective board. The sealing grooves are defined, in the outer surface of the protective board corresponding to the top surface of the positioning keel of the bearing base; the sealing grooves surround the axis of the bearing base to be evenly distributed and mutually communicated to form an enclosed ring structure. The auxiliary electrical power source includes a photovoltaic power generation plate, a wind power generator, a wind driven impeller, a wind, guide groove, a charging-discharging controller and a storage battery. The wind guide groove is located on an outer upper surface of the sealing top cap, and a cross section of the wind guide groove along an axis thereof is an isosceles structure. An area of an air inlet is at least three times larger than an area of an air outlet of the wind guide groove. The wind power generator is embedded in the wind guide groove and located in the air outlet to be connected with the wind driven impeller. The photovoltaic power generation, plate is embedded in the sealing top cap and an outer surface of the wind guide groove. The charging-discharging controller and the storage battery both are mounted on the outer surface of the wind guide groove by slides and electrically connected with the photovoltaic power generation plate, the wind power generator, the thermostat, the air purifiers and the control system respectively. The thermostat is mounted on a bottom surface of the bearing base by the slide and communicated with the airtightness bearing cavity through heat exchangers. The heat exchangers surround an axis of the airtightness bearing cavity to be evenly distributed on an inner surface of the airtightness bearing cavity. The air purifiers are evenly distributed on the inner surface of the airtightness bearing cavity to surround a center of the airtightness bearing cavity. The air purifier includes a positioning base, an anion generator, an electrostatic grid and an irradiation inactivation device; the anion generator, the electrostatic grid and the irradiation inactivation device are mounted on the positioning base. The control system is embedded in an outer surface of the protective lateral walls and electrically connected with the auxiliary electrical power source, the thermostat and the air purifiers respectively.

Furthermore, elastic sealing strips are disposed between contact surfaces of the reinforced guide rails and the protective lateral walls, as well as between contact surfaces of the protective lateral walls and the sealing grooves.

Furthermore, the protective lateral walls are connected with the bearing columns by the connecting slides to cover outer sides of the bearing columns.

Furthermore, the enclosed cavity structure formed by the protective boards and the positioning keel is disposed with an insulated cotton filling layer.

Furthermore, the number of the positioning keel is at least one, and adjacent positioning keels are hinge jointed by a ratchet mechanism.

Furthermore, the air inlet of the wind guide, groove is disposed with an air filter. The wind guide groove is further communicated with the airtightness bearing cavity through a draft tube.

Furthermore, the elastic positioning mechanism includes connecting positioning plates, an elastic positioning matrix, energy absorption spring sets, a reset spring, a slip sleeve and a guide column. The number of the connecting positioning plates is at least two, and the connecting positioning plates are symmetrically distributed on a top surface and a bottom surface of the elastic positioning matrix; the energy absorption spring sets, the reset spring, the slip sleeve and the guide column are embedded in the elastic positioning matrix. The slip sleeve and the guide column are distributed in an identical direction with an axis of the elastic positioning matrix, and a front end of the guide column is embedded in the slip sleeve and glidingly connected with the slip sleeve; another end of the guide column and the connecting positioning plates on a top surface of the elastic positioning matrix are vertically connected. The slip sleeve and the connecting positioning plate on the bottom surface of the elastic positioning matrix are vertically connected. The energy absorption spring sets surround an axis of the slip sleeve to be evenly distributed. The reset spring is embedded in the slip sleeve, and a front end thereof leans against the guide column while another end thereof leans against the connecting positioning plate.

The structure of the disclosure is simple, and the utilization is adjustable and convenient. On one hand, the volume of the freight container can be adjusted according to the requirement in, usage; on the other hand, superior abilities such as anti-vibration and anti-impact can be achieved; the external impact can be well absorbed and slowly released; the ambient temperature and stable air quality in the freight container can be guaranteed simultaneously, and pernicious microorganisms can be killed as well. As a result, the stability and reliability of the freight ambience can be considerably improved. Meanwhile, the autonomous function is further included. In the operational process of the freight container, the wind energy and the solar energy can be effectively utilized to reduce the power consumption for operating the freight container and driving the transportation vehicle.

### BRIEF DESCRIPTION OF THE DRAWINGS

FIG. 1 is a schematic view of a structure of the disclosure;

FIG. 2 is a partial structural schematic view of a bearing base, a protective lateral wall and a sealing top cap;

FIG. 3 is a structural schematic view of an auxiliary electrical power source;

FIG. 4 is a structural schematic view of an elastic positioning mechanism.

### DETAILED DESCRIPTION OF PREFERRED EMBODIMENTS

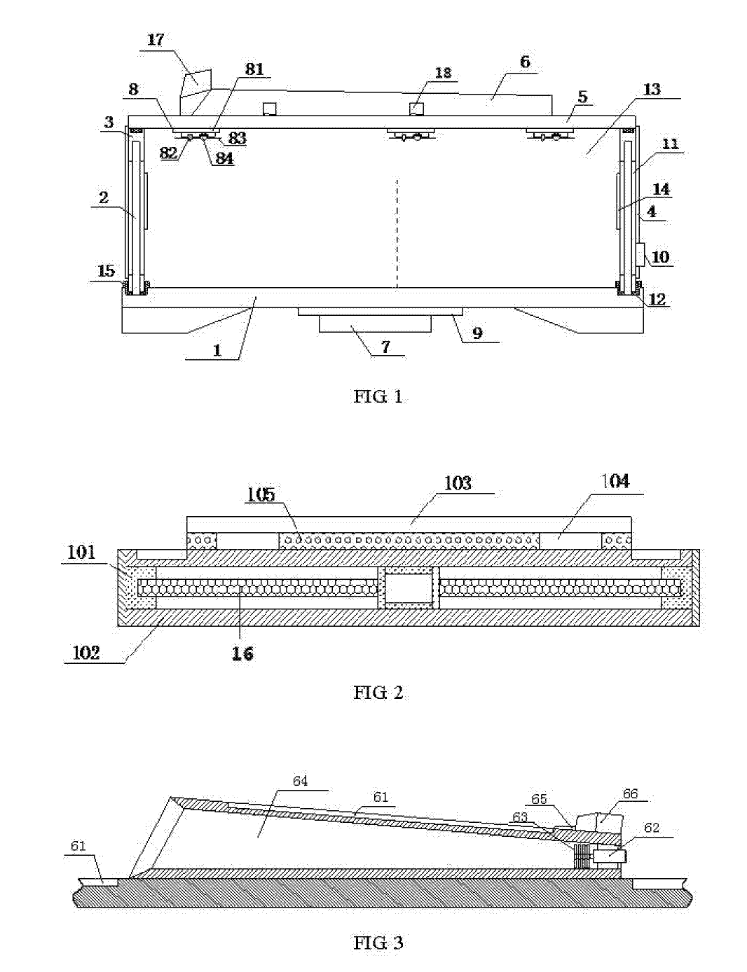

FIG. 1 shows a freight container with a high performance and an invariable storage ambience, including a bearing base 1, bearing columns 2, protective lateral walls 3, a reinforced guide rail 4, a sealing top cap 5, an auxiliary electrical power source 6, a thermostat 7, air purifiers 8 and a control system 10. The number of bearing columns 2 is at least four, and the bearing columns 2 surround an axis of the bearing base 1 to be evenly distributed on a top surface of the bearing base 1. The bearing columns 2 are distributed perpendicularly to the top surface of the bearing base 1. An outer surface of the bearing column 2 is disposed with at least two connecting slides 11, and the connecting slides 11 surround an axis of the bearing column 2 to be evenly distributed; the connecting slides 11 and the axis of the bearing column 2 are distributed parallel. The protective lateral walls 3 are connected with the bearing columns 2 by the connecting slides 11. Adjacent protective lateral walls 3 are mutually connected by reinforced guide rails 4. Positions on the top surface of the bearing base 1 corresponding to the protective lateral walls 3 are defined with sealing grooves 12 to be connected with the protective lateral walls 3 by the sealing grooves 12. Top ends of the protective lateral walls 3 are disposed with the connecting slides 11 to be glidingly connected with the sealing top cap 5 by the connecting slides 11. The bearing base 1, the protective lateral walls 3 and the sealing top cap 5 together form an airtightness bearing cavity 13.

As shown in FIG. 2, the bearing base 1, the protective lateral wall 3 and the sealing top cap 4 in the embodiment each include a positioning keel 101, protective boards 102 and a workbench 103. The positioning keel 101 is a planar rectangular frame structure. The protective boards 102 cover the outer sides of the positioning keel 101 to form an enclosed cavity structure. An outer surface of the protective board 102 corresponding to the top surface of the positioning keel 101 is connected with the workbench 103 by elastic positioning mechanisms 104; the workbench 103 and the top surface of the positioning keel 101 are distributed parallel. An elastic sealing layer 105 is disposed between the workbench 103 and the protective board 102. The sealing grooves 12 are defined in the outer surface of the protective board 102 correspondin to the top surface of the positioning keel 101 of the bearing base 1; the sealing grooves 12 surround the axis of the bearing base 1 to be evenly distributed and mutually communicated to form an enclosed ring structure.

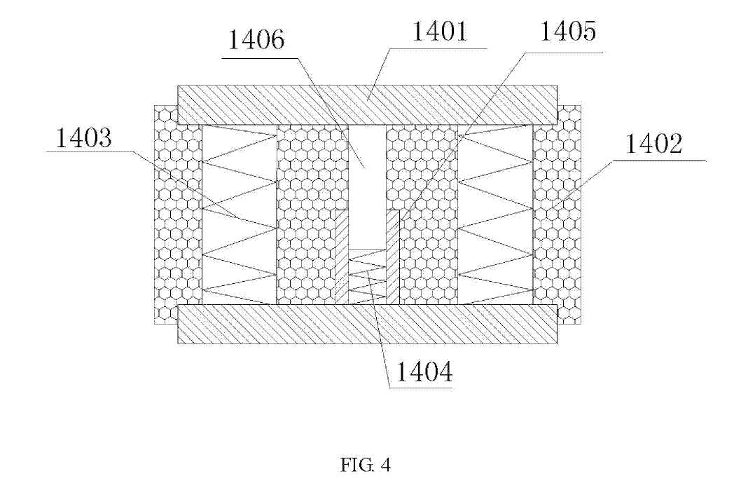

As shown in FIG. 3, the auxiliary electrical power source 6 in the embodiment includes a photovoltaic power generation plate 61 a wind power generator 62, a wind driven impeller 63, a wind guide groove 64, a charging-discharging controller 65 and a storage battery 66. The wind guide groove 64 is located on an outer upper surface of the sealing top cap 5, and a cross section of the wind guide groove 64 along the axis thereof is an isosceles structure. An area of an air inlet is at least three times larger than an area of an air outlet of the wind guide groove 64. The wind power generator 62 is embedded in the wind guide groove 64 and located in the air outlet to be connected with the wind driven impeller 63. The photovoltaic power generation plate 61 is embedded in the sealing top cap 5 and the outer surface of the wind guide groove 64. The charging-discharging controller 65 and the storage battery 66 both are mounted on the outer surface of the wind guide groove 64 by a slide 9 and electrically connected with the photovoltaic power generation plate 61, the wind power generator 62, the thermostat 7, the air purifiers 8 and the control system 10 respectively.

In the embodiment, the thermostat 7 is mounted on a bottom surface of the bearing base 1 by the slide 9 and communicated with the bearing cavity 13 through heat exchangers 14. The heat exchangers 14 surround the axis of the bearing cavity 13 to be evenly distributed on an inner surface of the bearing cavity 13. The air purifiers are evenly distributed on the inner surface of the bearing cavity to surround a center of the bearing cavity.

In the embodiment, the air purifier 8 includes a positioning base 81, an anion generator 82, an electrostatic grid 83 and an irradiation inactivation device 84. The anion generator 82, the electrostatic grid 83 and the irradiation inactivation device 84 are mounted on the positioning base 81.

In the embodiment, the control system 10 is embedded in an outer surface of the protective lateral walls 2 and electrically connected with the auxiliary electrical power source 6, the thermostat 7 and the air purifiers 8 respectively.

In the embodiment, elastic sealing strips 15 are disposed between contact surfaces of the reinforced guide rail 4 and the protective lateral wall 3, as well as contact surfaces of the protective lateral wall 3 and the sealing groove 12.

In the embodiment, the protective lateral walls 3 are connected with the bearing columns 2 by the connecting slides 11 to cover the outer sides of the bearing columns 2.

In the embodiment, the enclosed cavity structure formed by the protective boards 102 and the positioning keel 101 is disposed with an insulated cotton filling layer 16.

In the embodiment, the number of the positioning keel 101 is at least one, and adjacent positioning keels 101 are hinge jointed by a ratchet mechanism.

In the embodiment, the air inlet of the Wind guide groove 64 is disposed with an air filter 17. The wind guide groove 64 is further communicated with the bearing cavity 13 through a draft tube 18.

As shown in FIG. 4, the elastic positioning mechanism 104 in the embodiment includes connecting positioning plates 1401, elastic positioning matrixes 1402, energy absorption spring sets 1403 a reset spring 1404, a slip sleeve 1405 and a guide column 1406. The number of the connecting positioning plates 1401 is at least two, and the connecting positioning plates 1401 are symmetrically distributed on the top surface and the bottom surface of the elastic positioning matrixes 1402. The energy absorption spring sets 1403, the reset spring 1404, the slip sleeve 1405 and the guide column 1406 are embedded in the elastic positioning matrixes 1402. The slip sleeve and the guide column are distributed in an identical direction with axes of the elastic positioning matrixes, and a front end of the guide column is embedded in the slip sleeve and glidingly connected with the slip sleeve. The other end of the guide column and the connecting positioning plate on the top surface of the elastic positioning matrixes are vertically connected. The slip sleeve and the connecting positioning plate on the bottom surface of the elastic positioning matrixes are vertically connected. The energy absorption spring sets surround an axis of the slip sleeve to be evenly distributed. The reset spring is embedded in the slip sleeve, and a front end thereof leans against the guide column while the other end thereof leans against the connecting positioning plate.

The structure of the disclosure is simple, and the utilization is adjustable and convenient. On one hand, the volume of the freight container can be adjusted according to the requirement in usage; on the other hand, superior abilities such as anti-vibration and anti-impact can be achieved; the external impact can be well absorbed and slowly released; the ambient temperature and stable air quality in the freight container can be guaranteed simultaneously, and pernicious microorganisms can, be eliminated as well. As a result, the stability and, reliability of the freight ambience can be considerably improved. Meanwhile, the autonomous function is further included. In the operational process of the freight container, the wind energy and the solar energy can be effectively utilized to reduce the power consumption for operating the freight container and driving the transportation vehicle.

The above shows and describes the fundamental principle, primary properties and advantages of the disclosure. A person skilled in the art should understand that the disclosure will not be restricted to the aforementioned embodiments. The description in the embodiments described above and the specification purely for illustrating the principle of the disclosure. The disclosure can be modified and improved without excluding from the spirit and the scope of the disclosure. The modification and improvement should be included in the scope of the disclosure claimed to be protected. The scope of the disclosure claimed to be protected is defined by the attached claims and the counterparts.

What is claimed is:

1. A freight container with a high performance and an invariable storage ambience, wherein the freight container with a high performance and an invariable storage ambience comprises a bearing base, bearing columns, protective lateral walls, reinforced guide rails, a sealing top cap, an auxiliary electrical power source, a thermostat, air purifiers and a control system, the number of the bearing columns is at least four, and the bearing columns surround an axis of the bearing base to be evenly distributed on a top surface of the bearing base, the bearing columns are distributed perpendicularly to the top surface of the bearing base, an outer surface of the bearing column is disposed with at least two connecting slides, and the at least two connecting slides surround an axis of the bearing column to be evenly distributed; the at least two connecting slides and the axis of the bearing column are distributed parallel, the protective lateral walls are connected with the bearing columns by the at least two connecting slides, adjacent protective lateral walls are mutually connected by the reinforced guide rails, positions on the top surface of the bearing base corresponding to the protective lateral walls are defined with sealing grooves to be connected with the protective lateral walls by the sealing grooves, top ends of the protective lateral walls are disposed with connecting slides to be glidingly connected with the sealing top cap by the connecting slides, the bearing base, the protective lateral walls and the sealing top cap together form an airtightness bearing cavity; the bearing base, the protective lateral wall and the sealing top cap each include a positioning keel, protective boards and a workbench, the positioning keel is a planar rectangular frame structure, the protective boards cover outer sides of the positioning keel to form an enclosed cavity structure, an outer surface of the protective boards corresponding to a top surface of the positioning keel is connected with the workbench by an elastic positioning mechanism; the workbench and the top surface of the positioning keel are distributed parallel, an elastic sealing layer is disposed between the workbench and the protective board, the sealing grooves are defined in the outer surface of the protective board corresponding to the top surface of the positioning keel of the bearing base; the sealing grooves surround the axis of the bearing base to be evenly distributed and mutually communicated to form an enclosed ring structure, the auxiliary electrical power source comprises a photovoltaic power generation plate, a wind power generator, a wind driven impeller, a wind guide groove, a charging-discharging controller and a storage battery, the wind guide groove is located on an outer upper surface of the sealing top cap, and a cross section of the wind guide groove along an axis thereof is an isosceles structure, an area of an air inlet is at least three times larger than an area of an air outlet of the wind guide groove, the wind, power generator is embedded in the wind guide groove and located in the air outlet to be connected with the wind driven impeller, the photovoltaic power generation plate is embedded in the sealing top cap and an outer surface of the wind guide groove, the charging-discharging controller and the storage battery both are mounted on the outer surface of the wind guide groove by slides and electrically connected with the photovoltaic power generation plate, the wind power generator, the thermostat, the air purifiers and the control system respectively, the thermostat is mounted on a bottom surface of the bearing base by the slide and communicated with the airtightness bearing cavity through heat exchangers, the heat exchangers surround an axis of the airtightness bearing cavity to be evenly distributed on an inner surface of the airtightness bearing cavity, the air purifiers are evenly distributed on the inner surface of the airtightness bearing cavity to surround a center of the airtightness bearing cavity, the air purifier comprises a positioning base, an anion generator, an electrostatic grid and an irradiation inactivation device; the anion generator, the electrostatic grid and the irradiation inactivation device are mounted on the positioning base, the control system is embedded in an outer surface of the protective lateral walls and electrically connected with the auxiliary electrical power source, the thermostat and the air purifiers respectively.

2. The freight container with a high performance and an invariable storage ambience according to claim 1, wherein elastic sealing strips are disposed between contact surfaces of the reinforced guide rails and the protective lateral walls, as well as between contact surfaces of the protective lateral walls and the sealing grooves.

3. The freight container with a high performance and an invariable storage ambience according to claim 1, wherein the protective lateral walls are connected with the bearing columns by the connecting slides to cover outer sides of the bearing, columns.

4. The freight container with a high performance and an invariable storage ambience according to claim 1, wherein the enclosed cavity structure formed by the protective boards and the positioning keel is disposed with an insulated cotton filling layer.

5. The freight container with a high performance and an invariable storage ambience according to claim 1, wherein the number of the positioning keel is at least one, and adjacent positioning keels are hinge jointed by a ratchet mechanism.

6. The freight container with a high performance and an invariable storage ambience according to claim 1, wherein the air inlet of the wind guide groove is disposed with an air filter, the wind guide groove is further communicated with the airtightness bearing cavity through a draft tube.

7. The freight container with a high performance and an invariable storage ambience according to claim 1, wherein the elastic positioning mechanism comprises connecting positioning plates, an elastic positioning matrix, energy absorption spring sets, a reset spring, a slip sleeve and a guide column, the number of the connecting positioning plates is at least two, and the connecting positioning plates are symmetrically distributed on a top surface and a bottom surface of the elastic positioning matrix; the energy absorption spring sets, the reset spring, the slip sleeve and the guide column are embedded in the elastic positioning matrix, the slip sleeve and the guide column are distributed in an identical direction with an axis of the elastic positioning matrix, and a front end of the guide column is embedded in the slip sleeve and glidingly connected with the slip sleeve, another end of the guide column and the connecting positioning plates on a top surface of the elastic positioning matrix are vertically connected, the slip sleeve and the connecting positioning plate on the bottom surface of the elastic positioning matrix are vertically connected, the energy absorption spring sets surround an axis of the slip sleeve to be evenly distributed, the reset spring is embedded in the slip sleeve, and a front end thereof leans against the guide column while another end thereof leans against the connecting positioning plate.
